(19) United States
(12) Patent Application Publication
(10) Pub. No.: US 2020/0018210 A1
(43) Pub. Date: Jan. 16, 2020

(54) SCR METHOD FOR REDUCING OXIDES OF NITROGEN AND METHOD FOR PRODUCING A CATALYST FOR SUCH METHOD

(71) Applicant: Johnson Matthey Public Limited Company, London (GB)

(72) Inventors: Juergen BAUER, Redwitz (DE); Sofia LOPEZ-OROZCO, Redwitz (DE); Joerg Werner MUENCH, Redwitz (DE)

(21) Appl. No.: 16/449,598

(22) Filed: Jun. 24, 2019

Related U.S. Application Data
(63) Continuation of application No. 15/129,625, filed on Sep. 27, 2016.

(30) Foreign Application Priority Data
Mar. 27, 2014 (DE) 102014205783.3

(51) Int. Cl. F01N 3/20; B01J 29/04; B01J 29/74; B01J 29/72; B01J 29/70; B01J 35/10; B01J 37/02; B01J 37/30; B01D 53/94; B01J 35/04; B01J 29/76; B01J 37/00; F01N 3/28

(52) U.S. Cl. CPC F01N 3/2066; B01J 2229/18; B01J 29/743; B01J 29/044; B01J 29/042; B01J 29/723; B01J 29/041; B01J 29/7015; B01J 35/109; B01J 35/1061; B01J 37/0201; B01J 37/30; B01D 53/9418; B01J 35/04; B01J 29/763; B01J 37/0009; F01N 3/2842; B01J 2229/186; B01J 2229/30; B01J 2229/14; B01J 2229/38; B01J 2229/42; B01D 2255/20738; B01D 2255/20761; B01D 2255/50; B01D 2255/9155; B01J 29/043

(57) ABSTRACT

A method of reducing nitrogen oxides in exhaust gas of an internal combustion engine by selective catalytic reduction (SCR) comprises contacting the exhaust gas also containing ammonia and oxygen with a catalytic converter comprising a catalyst (2) comprising at least one crystalline small-pore molecular sieve catalytically active component (Z_{M,I}) having a maximum ring opening of eight tetrahedral basic building blocks, which crystalline small-pore molecular sieve catalytically active component (Z_{M,I}) comprising mesopores.

The invention relates to a method of reducing nitrogen oxides in exhaust gas of an internal combustion engine by selective catalytic reduction (SCR), which method comprising contacting the exhaust gas also containing ammonia and oxygen with a catalytic converter comprising a catalyst and also to a method for producing a catalyst for such use.

Reduction in nitrogen oxide levels in exhaust gases from both stationary and mobile combustion systems, more particularly in the case of motor vehicles, is accomplished using the known method of selective catalytic reduction (SCR). This involves reducing nitrogen oxides to nitrogen in the presence of ammonia and oxygen. Various types of catalyst and systems are known in principle for the acceleration of this reaction. One class of catalyst which has been in the spotlight relatively recently, especially for mobile use with motor vehicles, is that of catalysts based on crystalline molecular sieves, and more particularly zeolite-based catalytic converters. Particularly noteworthy catalytically active components here include iron-exchanged or copper-exchanged zeolites.

The molecular sieves, more particularly zeolites, have a specific morphology with a high microporosity relative to the volume, and as a result have a comparatively large surface area, so making them suitable for compact installation. The catalytic activity is obtained by virtue of the incorporation of copper or iron ions.

The catalytic converters nowadays used in motor vehicles are usually catalyst washcoats coated on inert ceramic substrates, particularly honeycomb ceramic substrates. Alternatively, modern catalytic converters can be extruded ceramic catalysts, typically in the form of a honeycomb body. In operation, the exhaust gas to be cleaned flows through channels in the coated substrate or extruded catalyst body.

A basic distinction is drawn here between what are called all-active extrudates and coated supports, known as “washcoats”. In the case of the all-active extrudates, the extruded body is comprised of a catalytically active catalyst material, meaning that the individual channel walls of the catalyst are formed entirely of a catalytically active material. In the case of the washcoats, a catalytically inert, extruded support body is coated with the actually catalytically active catalyst material. This is done, usually, by dipping the extruded support body into a suspension comprising the catalyst material.

To produce the extruded catalyst body, generally, a ceramic extrusion composition is provided with rheological properties set appropriately for the extrusion process. This extrusion compound is a plastic (i.e. easily shaped or mouldable) mass. In order to set the desired rheological properties, binders or else additives are typically added to the extrusion compound.

In the case of all-active extrudates, the catalytically active component is present in the extrusion composition. With conventional catalysts, based for example on the titanium dioxide/vanadium pentoxide system, the binder fraction is typically in the region of a few percent by weight, as for example in the range from 2 to 8 wt %.

Where zeolites are used as a catalytically active component, however, extrusion is made more difficult, since the zeolites are comparatively difficult to extrude. Another problem is also seen in the reduced mechanical stability of zeolite-based catalyst systems. In light of this it is necessary to use much higher binder fractions—by comparison with the titanium dioxide/vanadium pentoxide systems—in order to set the rheological properties appropriately for extrusion and also in order to achieve sufficient mechanical stability.

As a result of this, however, the quantity of catalytically active component is diminished overall relative to the catalyst as a whole, with the overall consequence of a reduction in the specific catalytic activity per unit volume, as a result of the increased binder fraction.

The term “binder” here refers generally to a component which endows the ceramic catalyst ultimately produced, after a sintering operation, with strength and stability. This binder in particular forms sinter bridges to the catalytically active component, or brings about mechanical interengagement between these components.

With regard to the catalysts, the aim in principle is for a maximum catalytic activity, in other words a level of NOx conversion that is as high as possible. Critical to this aim is extremely efficient contact between the catalytically active material and the exhaust gas to be cleaned. The catalytic conversion takes place crucially in the near-surface region on the walls of a particular flow channel through which the exhaust gas flows. As a result, particularly in the case of all-active extrudate honeycomb catalysts, where the entire extruded body consists of the catalytically active material, is that comparatively large volume regions of the catalyst material remain unutilized for NOx conversion.

Where crystalline molecular sieves, more particularly zeolites, are used as a catalytically active component, the porosity of these components means that there is a very large surface area of the catalyst available near the surface. Particularly in the case of so-called small-pore zeolites, however, especially in combination with high crystal sizes, in the μm range, for example, it is more difficult for the exhaust gas for cleaning to access lower-lying volume regions of the zeolite.

Distinctions are drawn generally between so-called small-pore, medium-pore, wide-pore and ultra-wide-pore molecular sieves. This classification is made on the basis of pores with a pore width that are accessible to gas molecules from the outside. This pore width is defined by the diameter of the ring opening of a ring structure of the molecular sieve. Suitable crystalline molecular sieves have open pores or pore channels which are formed and delimited by a ring structure of usually tetrahedral basic building blocks of the molecular sieve, e.g. zeolite. “Small-pore” refers to a pore structure in which the maximum ring opening is formed by a ring composed of eight such basic building blocks. “Medium-pore” and “wide-pore” refer to pore structures in which the maximum ring opening is formed by a ring of 10 to 12 basic building blocks respectively. Ultra-wide-pore pores have a ring opening formed by more than 12 basic building blocks. In zeolites presently known, the maximum ring size lies at a ring structure with 24 basic building blocks. The pore width in the case of an eight-block ring, in other words in the case of small-pore zeolites, is typically only around 0.3 nm, and about 0.5 nm in the case of medium-pore zeolites.

On this basis, the problem addressed by the invention is that of specifying a method of reducing nitrogen oxides in exhaust gas of an internal combustion engine by selective catalytic reduction (SCR) using a catalyst, especially an extruded SCR catalyst, based on a molecular sieve having good catalytic activity.

### BRIEF DESCRIPTION OF THE DRAWINGS

FIG. 1 is a schematic illustrating a method for producing a catalyst, in which mesopores are formed and metal ion exchange takes place before extrusion.

FIG. 2 is a schematic illustrating a method for producing a catalyst, in which mesopores are formed and metal ion exchange takes place after extrusion.

### DETAILED DESCRIPTION OF INVENTION

The problem is solved in accordance with the invention by a method having the features of 5 claim 1. The catalyst takes the form in particular of an SCR catalyst for reduction in levels of nitrogen oxides. The catalyst has at least one small-pore, microporous catalytically active component. This catalytically active small-pore component contains mesopores introduced by a specific alkaline aftertreatment.

Methods of making the crystalline small-pore molecular sieve catalytically active component (Z_{M,I}) having a maximum ring opening of eight tetrahedral basic building blocks and mesopores introduced by alkaline treatment are known from the prior art, such as US 2012/0258852 A1, US 2011/0118107 A1 and US 2013/0299389 A1 (the entire contents of which is incorporated herein by reference).

Mesopores here are understood as pores having a pore width in the range from 2 to 50 nm in accordance with the IUPAC (International Union of Pure and Applied Chemistry) notation. The catalytically active component is a component which is microporous in the original state, in other words prior to the introduction of the mesopores. This component therefore has a pore structure with pores whose width is defined by a ring opening with a maximum of eight basic building blocks. The pore structure in this case is microporous —according to the IUPAC notation, therefore, the pore diameter is below 2 nm.

In principle, as well as the small-pore pore structure, the microporous component may also have a larger pore structure, i.e. a medium-pore or wide-pore structure. Preferably, however, a small-pore component means a component in which the entire pore structure is formed exclusively by no more than 8-block-ring pores. Only as a result of the treatment are mesopores introduced, which form, so to speak, “flow channels” having a pore width enlarged relative to that of the micropores, and which ensure improved diffusion of the exhaust gas to be cleaned, including its diffusion into lower-lying layers of the catalytically active component. As a result of this measure, therefore, a greater volume region of the catalytically active component is utilized, and so overall the catalytic activity is improved.

Also made possible here, in addition to the accessibility to active cells within the catalyst by the exhaust gas to be cleaned, this accessibility being improved as a result, is an improved NH₃ absorption and storage. The storage here is particularly important under transient conditions, in other words in the case of internal-combustion engines with changes in load.

In the original condition, the small-pore component consists generally of a powder with particles having a size in the range from a few μm up to several tens of μm. The individual particles here exhibit the microporosity, with a maximum pore width of about 1 nm at most.

Mesopores are introduced by an alkaline aftertreatment of the microporous crystals of the small-pore component. An example of a procedure for introduction of the mesopores is as follows:

A starting zeolite (in the Na form, the H form or else the already ion-exchanged Cu form) is suspended in 0.2M NaOH solution, with a solid/liquid ratio of 0.05 g/ml and at temperatures of 60° C., for 1 hour and is then filtered, washed with deionized water and dried at room temperature for 12 hours. In order to obtain the catalytically active form, this alkali treatment is followed by further treatment steps (such as ammonium exchange, copper exchange, etc., for example).

The small-pore catalytically active component comprises more particularly a crystalline molecular sieve, preferably a zeolite. The term “crystalline molecular sieve” refers here in particular to zeolites in the narrower sense—that is, to crystalline aluminosilicates.

Crystalline molecular sieves are additionally taken to include other molecular sieves as well, which are not aluminosilicates but which have a zeolitic framework structure as apparent from the zeolite atlas of the Structure Commission of the International Zeolite Association (IZA-SC). This relates in particular to silicoaluminophosphates (SAPO) or else aluminophosphates (ALPO), which are likewise included in the aforementioned zeolite atlas.

Preferably the molecular sieve comprises generally a metallic activator (promoter). This is, in particular, copper or iron or else cerium, or a mixture thereof. More particularly the molecular sieve is a molecular sieve, more particularly zeolite, which has been exchanged with metal ions of this kind. As an alternative to the ion-exchanged molecular sieve, in which the metal ions are therefore incorporated in the framework structure, the possibility also exists for these metal activators not to be incorporated in the framework structure, and hence to be present, so to speak, as “free” metals or metal compounds (e.g. metal oxides) in the individual channels of the molecular sieves, as a result, for example, of the impregnation of the molecular sieve with a solution containing the compound. Another possibility is a combination of ion-exchanged metals and free metal compounds in the molecular sieve.

The catalytic activity of metal sieves of this kind which have been exchanged with catalytically active metal ions is particularly good. One of the particular advantages of introducing mesopores into small-pore molecular sieves is considered to be that the ion exchange, in other words the intercalation of the metal ions into the framework structure of the molecular sieve, is improved, since these ions are able more easily to penetrate into the volume as well via the mesopores. This is true particularly of iron ions, which in comparison to the copper ions have a larger diameter and can therefore hardly be introduced into the framework structure of a small-pore molecular sieve.

Used usefully as small-pore molecular sieves, alternatively or in combination, are molecular sieves with the framework types CHA, AEI, AFX or ERI. These framework types have ring openings with a maximum of eight basic building blocks. Additionally or instead, preference is also given to using zeolites with the framework types AFR or AFS. These types, as well as 8-block-ring structures, also have larger pore openings.

References presently to molecular sieves, more particularly to zeolites, are to be understood generally as references to molecular sieves according to the zeolite atlas of the Structure Commission of the International Zeolite Association (IZA-SC). The nomenclature used here goes back to the nomenclature used in that zeolite atlas.

The fraction of the small-pore catalytically active component is situated preferably in the range from 50 to 95 wt %, based on the total weight of the ultimately fabricated, sintered ceramic catalyst body.

In addition, the catalyst usefully has an inorganic binder component. This component on the one hand acts as a binding link between the zeolite particles, in order to ensure a mechanically robust catalyst after the sintering process itself. Furthermore, the binder component permits effective extrudability in the case of an extruded catalyst.

The fraction of this inorganic binder component is preferably in the range from 5 to 50 and more particularly in the range from 10 to 35 wt %. Besides the active component, more particularly the zeolite, and the binder fraction, there may also be further residual components such as, for example, fibres or other extrusion aids, etc., but the fraction of such components is preferably not more than 10 wt %.

An exemplary composition of a catalyst is for example as follows:

| Component | Fraction (wt %) |
|---|---|
| Cu ion-exchanged CHA zeolite | 60 |
| Al₂O₃ and clays | 31 |
| Glass fibres | 9 |

The effect of the comparatively high inorganic binder fraction is in particular to allow effective extrudability and at the same time to produce high strength. In order further to maintain the catalytic activity in view of this comparatively high inorganic binder fraction, in a useful development, the inorganic binder component, which is catalytically inactive in the original state, is catalytically activated. In the original state, the binder component consists of powder particles which have no catalytic activity. Through a specific treatment, these particles are given a catalytic activity and so contribute to the overall activity of the catalyst.

For this purpose, according to a first preferred embodiment, the individual particles are provided with a catalytically active coating. Alternatively or additionally, the catalytic activation is also accomplished by at least partial conversion of the framework structure of the powder particles, with retention of their particle form, into a zeolitic framework structure. “With retention of their particle form” here means that only changes in the range of nanostructure, i.e. in the range of up to 1 nm, are performed, whereas the larger structures, as for example the fundamental particle form or else a mesoporosity or macroporosity in the particles, are retained.

The particles of the binder component are usefully porous and have in particular a mesoporosity or macroporosity with pore widths of 2-50 nm (mesoporous) or pore widths of greater than 50 nm (macroporous). Similarly to the mesopores introduced into the zeolite, the porous particles of the binder component bring about effective mass transport of the exhaust gas that is to be cleaned, including into lower-lying layers of the catalyst.

The use of catalytically activated binder particles for a catalytic converter is described in the German patent application being filed simultaneously by the applicant, DE 10 2014 205 760.4, with the title “Process for producing a catalyst and catalyst”. That application is presently referenced in full, and its disclosure content is hereby incorporated.

The particles of the binder component are in particular a clay mineral or else a diatomaceous earth, or silica. Diatomaceous earth has emerged as being particularly suitable, on account of its high porosity. The diatomaceous earth is also employed in particular for at least partial conversion to a zeolite. Following the conversion to a zeolite, preferably, in addition, there is a metal ion exchange as well, in order to give an ion-exchanged zeolite, more particularly an iron-exchanged or copper-exchanged zeolite, having good catalytic activity.

Another material which has emerged as being suitable is a pillared clay mineral, featuring clay layers spaced apart by inorganic pillars. For catalytic activation, catalytically active centres are preferably introduced into interstices between the individual clay layers.

The catalyst is preferably in the form of an extruded catalyst, more particularly a honeycomb catalyst. For its production, accordingly, an extrudable, paste-like catalyst material is provided, comprising the various components of the catalyst, from which the catalyst body, more particularly honeycomb body, is then formed by extrusion, and is subsequently dried and sintered.

According to one variant, this catalyst body is coated with a catalytically active coating, which is either identical to or different from the extruded body. A coating of this kind is applied, for example, as a washcoat coating, as evident from DE 10 2012 213 639 A1 (the entire contents of which is incorporated herein by reference). More particularly the catalyst in question is an extruded SCR honeycomb catalyst. According to an alternative embodiment, no coating is applied.

In one preferred embodiment, the extruded catalyst, more particularly the extruded honeycomb catalyst, takes the form of what is called a wall-flow filter, in which the exhaust gas flows through porous walls in operation. In contrast, a flow-through monolith (which likewise frequently takes the form of a ceramic honeycomb catalyst) has a catalyst body which is permeated in the longitudinal direction by flow channels for the exhaust gas. Development to the wall-flow filter is accomplished by a suitable adjustment of the porosity. A wall-flow filter of this kind is described in DE 10 2011 010 106 A1, for example (the entire contents of which is incorporated herein by reference).

The catalyst preferably takes the form of an SCR catalyst, and therefore has catalytic activity for the desired deNOx reaction.

The concept described here, however, is not confined to use for SCR catalysts. This concept is suitable in principle for all kinds of catalytic converters, for the purpose of improving the catalytic activity.

More particularly the catalyst constitutes, for example, what is called a hydrocarbon trap, more particularly without additional catalytic coating. Catalytic converters of this kind are also referred to as cold-start catalysts, since on account of their storage capacity for hydrocarbons, they control the HC fraction in the exhaust gas during the start-up phase of an internal combustion engine. One such cold-start catalyst is described in WO 2012/166868 A1, for example (the entire contents of which is incorporated herein by reference). A catalyst of this type takes the form in particular of an extruded honeycomb catalyst with a crystalline molecular sieve, also in particular in the form of a mixture of a molecular sieve of this kind with a noble metal, more particularly palladium (Pd), for example. The noble metal here may also be added to the zeolite together with a base metal. Studies show that palladium-impregnated crystalline molecular sieves, in particular without iron, likewise exhibit the desired properties of a cold-start catalyst. Such cold-start catalysts display, for example, good NOₓ storage capacity and conversion capacity with high selectivity for N₂ at relatively low temperatures, good storage capacity and conversion of hydrocarbon at low temperatures, and also an improved carbon monoxide oxidation activity.

Alternatively to these preferably uncoated extruded catalysts, in the form of hydrocarbon traps, the catalyst takes the form of a coated, extruded honeycomb catalyst with the quality of a hydrocarbon trap. The catalyst in this case has crystalline molecular sieves, preferably, for example, in the H⁺ form and more particularly “unmetallized”, i.e. without metallic activators. Alternatively, the crystalline molecular sieves comprise palladium and/or silver. In this variant version, extruded honeycomb bodies of this kind are provided with a catalytically active coating, more particularly for the formation of a diesel oxidation catalyst or three-way catalyst, or have undergone conversion to a wall-flow filter which is subsequently coated with an oxidation catalyst in order to convert it—similarly to a diesel oxidation catalyst—into what is called a catalysed soot filter (CSF). One example of a three-way catalyst is disclosed in WO 2011/092517 A1 (the entire contents of which is incorporated herein by reference), and an example of an extruded diesel oxidation catalyst and also of an extruded catalysed soot filter is disclosed by WO 2011/092519, for example (the entire contents of which is incorporated herein by reference).

Furthermore, the catalyst may also take the form of a plate-type catalyst, or of bulk material in the form, for example, of extruded pellets, or in some other form.

Besides the small-pore catalytically active components treated by the introduction of mesopores, it is possible in principle for there to be further catalytically active components present as part of catalytic systems. The system in question in that case is preferably a non-zeolitic system based on a base metal.

In accordance with a first variant version, the catalyst in this case is a titanium-vanadium-based catalyst with vanadium as catalytically active component. Overall, in different variant versions, different titanium-vanadium systems are used. Use is made in particular of oxidic systems with mixtures of titanium dioxide (TiO₂) and vanadium pentoxide (V₂O₅). Alternatively, the titanium-vanadium system comprises vanadium-iron compounds as catalytically active component, comprising in particular iron vanadate (FeVO₄) and/or iron-aluminium vanadate (Fe_{0.8}Al_{0.2}VO₄). Such an arrangement is disclosed in WO 2014/027207 A1 (the entire contents of which is incorporated herein by reference)

In the case of the oxidic systems, these are more particularly titanium-vanadium-tungsten systems, titanium-vanadium-tungsten-silicon systems, titanium-vanadium-silicon systems. In the case of the second group with vanadium-iron compounds, these are titanium-vanadium-tungsten-iron systems, titanium-vanadium-tungsten-silicon-iron systems or titanium-vanadium-silicon-iron systems.

The titanium/vanadium weight ratio (Ti/V) here is usefully in the range between 35 and 90. In the case of oxidic titanium-vanadium systems, the weight ratio between titanium dioxide and vanadium pentoxide (TiO₂/V₂O₅) is typically in the range from 20 to 60.

According to a second variant of the catalytic system based on a base metal, a tungsten oxide-cerium oxide system or a stabilized tungsten oxide-cerium oxide system (WO₃/CeO₂) is used for the catalytic system. The stabilized tungsten/cerium system comprises more particularly a zirconium-stabilized system containing Ce-zirconium mixed oxides. Preference here is given to a transition metal, more particularly iron dispersed in a carrier material of this kind. The transition metals used are selected more particularly from the group consisting of Cr, Ce, Mn, Fe, Co, Ni, W and Cu and more particularly selected from the group consisting of Fe, W, Ce and Cu.

The catalytic system comprises more particularly an Fe—W/CeO₂ or an Fe—W/CeZrO₂ system, as described in particular in connection with FIG. 3 of WO 2009/001131 (the entire contents of which is incorporated herein by reference). The fraction of the transition metal in the catalyst in this case is in the range from 0.5 to 20 wt %, for example, based on the total weight of the catalyst.

The problem is further solved in accordance with the invention by a method for producing a catalyst, having the features of Claim 14. The advantages and preferred embodiments recited in relation to the catalyst may also be transposed mutatis mutandis to the method.

According to one preferred embodiment in this case, provision is made for—in a first step—the mesopores to be introduced into the small-pore component, in other words, more particularly, into the small-pore zeolites, and only then for catalytically active metal ions, more particularly copper ions or iron ions, to be introduced by ion exchange into the framework structure in order to form catalytically active cells. The formation of the mesopores prior to the ion exchange procedure promotes and simplifies the subsequent ion exchange procedure, producing improved, more homogeneous intercalation of metal ions and hence an improved catalytic activity.

In the production of a metal ion-exchanged zeolite, it is usual for a plurality of production steps to be performed. In a synthesis of the zeolite, first of all an alkaline starting form (Na⁺ form) is obtained, in which Na⁺ ions are incorporated in the lattice structure. The zeolite is usually next converted into an intermediate stage, specifically into which is called the ammonium form (NH₄⁺), or, through a further subsequent temperature treatment (calcining) into the H⁺ form, before subsequently the ion exchange with the copper ions or iron ions, for example, takes place.

In the alkaline treatment for introducing the mesoporosity, the ammonium or H^{t} form is at least partly converted back into the Na⁺ starting form. For the introduction of the copper ions or iron ions, the zeolite, according to a first preferred alternative, is first converted —after the introduction of the mesoporosity—into the ammonium form or H^{t} form, before the copper or iron ion exchange is subsequently carried out.

Studies have shown, however, that a direct ion exchange between the sodium ions of the Na⁺ starting form and the copper metal or iron metal ions is better. Accordingly, in a second version, the intermediate step of generating the ammonium form or H⁺ form is preferably omitted, and the metal ion exchange with the catalytically active metal ions is carried out directly after the introduction of the mesopores, without intervening conversion into the ammonium form or H⁺ form.

It is useful to forgo conversion of the Na⁺ initial form as early as during the provision of the zeolitic starting powder. By this means the production costs can be reduced.

In a useful embodiment, in the method, a formable catalyst material is provided first of all, more particularly as an extrusion compound. Formed subsequently from this compound is a shaped body, more particularly an extruded honeycomb body with flow channels for the exhaust gas to be cleaned. Only after this shaped body has been formed are the mesopores introduced into the small-pore zeolite. The particular advantage in this case is seen as being that, as a result, the mesopores already have a preferential orientation, oriented into the volume of the catalyst material by the interfaces between flow channel and catalyst material. As a result, in a particularly efficient way, coarse-pore flow channels, reaching into the volume of the catalyst material, are generated for the exhaust gas to be cleaned. The overall result of this is improved accessibility of the active cells within the volume of the catalyst. With this variant version as well, metal-ion exchange takes place preferably after the introduction of the mesopores, in order to obtain more effective cation distribution.

The introduction of the mesopores and the subsequent ion exchange therefore alternatively take place in the initial powder state of the zeolite or else in the processed state, for example as an extruded honeycomb body with a zeolite.

Working examples of the invention are elucidated in more detail below using two figures, which in schematized form illustrate the method for producing the catalyst in two different variants.

In both variants, an extruded SCR honeycomb catalyst 2 is produced as a fully manufactured sintered body. In both cases, from different starting components, an extrudable catalyst material E is first of all provided, and is extruded into a honeycomb body 4 having flow channels 6. After drying, the honeycomb body is sintered to form the fully fabricated catalyst 2. In both method variants, the catalyst 2 consists of a small-pore zeolite Z_{M,I}, catalytically active, ion-exchanged and provided with mesopores, and of a catalytically activated binder component B_{A}, and also, as and when required, of a further solid component R.

The indices M and I here stand for a small-pore zeolite with incorporated mesopores (index M) and also for an ion-exchanged zeolite (index I), in which case, in particular, copper ions or else iron ions have been introduced into the microstructure. The index A for the binder component B indicates that the individual particles of the binder component B are catalytically activated.

The zeolite Z_{M,I} preferably comprises a zeolite with the framework type CHA. Alternatively or in combination, as small-pore zeolites, zeolites of framework types AEI/ERI are used. Instead or additionally, zeolites of framework types AFX, AFR and/or AFS are used.

Employed preferably as binder component B_{A} is a catalytically activated diatomaceous earth. The catalytic activation in this case is accomplished in particular by partial or complete conversion of the microstructure into a zeolite microstructure, preferably of the same type as that of the zeolite Z_{M,I} used as active component.

The binder component B_{A} need not necessarily be catalytically activated. Studies have shown that simply by the introduction of a porous binder component B, such as diatomaceous earth, in spite of an accompanying reduction in the amount of catalytically active material, the catalytic activity of the catalyst (given identical overall weight) is at least constant, since the meso- or macroporosity of the binder component B enables improved accessibility to the active centres within the catalyst material.

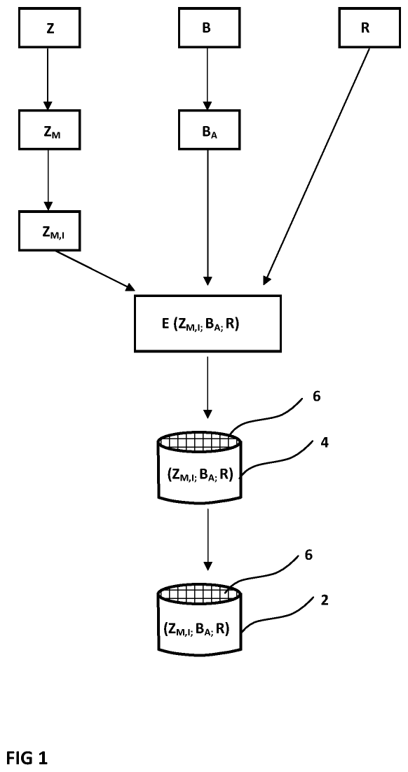

In the variant version according to FIG. 1, a small-pore zeolite Z, which has not been ion-exchanged or provided with mesopores, is employed initially as starting material. This zeolite is customarily in powder form. In a first treatment stage, mesopores are introduced in the manner described into this small-pore zeolite, producing a small-pore zeolite Z_{M} provided with mesopores. Finally, in a way known per se, an ion exchange is performed, in which copper ions, in particular, are introduced into the framework structure, producing an ion-exchanged zeolite Z_{M,I}, provided with mesopores, in powder form.

The binder component B is catalytically activated in a preparatory step, producing a catalytically activated binder component B_{A}. This component, together with the ion-exchanged small-pore zeolite Z provided with mesopores, and optionally with admixture of a residual fraction R, comprising for example an inorganic porous filler or else fibre fraction, is combined to form the extrudable compound E. The only subsequent steps are the extrusion to form the honeycomb body 4, and finally the drying and sintering to form the catalyst 2.

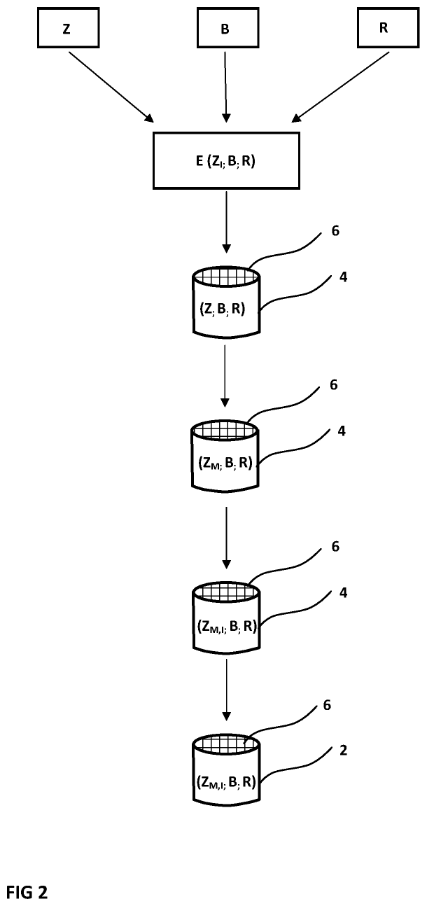

In the variant version according to FIG. 2, the formation of the mesopores and the metal ion exchange take place only after extrusion, or, generally, after shaping of a catalyst body from a catalyst material. In the case of a washcoat, therefore, these steps would not take place until after the application of the catalyst material on the inert support.

Consequently, a small-pore zeolite Z, which has not been ion-exchanged and has not been provided with mesopores either, together with a binder component B, which in this working example has not been activated, and also, as and when necessary, with a fraction R, is combined to form the extrudable compound E, and is subsequently extruded to give the honeycomb body 4. In the subsequent method step, the honeycomb body 4 produced is subjected to an alkaline treatment, converting the zeolite Z into a zeolite Z_{M} provided with mesopores. This is followed by metal ion exchange, producing the desired state of the ion-exchanged zeolite Z_{M,I} provided with mesopores. After that, there is sintering to give the fully fabricated catalyst 2.

The particular advantage in this case is to be seen in the fact that the mesopores begin from the flow channels 6, and so have a defined preferential orientation. As a consequence, in subsequent deployment, more effective transport of exhaust gas into the volume of the catalyst material is made possible.

The invention can also be defined according to one or more of the following:
1. Catalyst (2), especially SCR catalyst, comprising at least one small-pore, microporous catalytically active component (Z_{M,I}), this small-pore catalytically active component (Z_{M,I}) comprising mesopores introduced by alkaline treatment.
2. Catalyst (2) according to 1, the small-pore, microporous catalytically active component being a molecular sieve, more particularly a zeolite (Z_{M,I}).
3. Catalyst (2) according to 2, the molecular sieve comprising a metallic activator and being more particularly an ion-exchanged zeolite (Z_{M,I}).
4. Catalyst (2) according to 2 or 3, a molecular sieve having the framework structure CHA, AEI, ERI or AFX being used alternatively or in combination as small-pore catalytically active molecular sieve (Z_{M,I}).
5. Catalyst (2) according to any of 1 to 4, wherein the fraction of the small-pore, microporous catalytically active component (Z_{M,I}) being in the range from 50 to 95 wt %.
6. Catalyst (2) according to any of 1 to 5, comprising an inorganic binder component (B,B_{A}).
7. Catalyst (2) according to 6, in which the inorganic binder component (B,B_{A}) comprises porous particles.
8. Catalyst converter (2) according to 6 or 7, in which the inorganic binder component (B_{A}) is catalytically activated.
9. Catalyst (2) according to 8, in which the inorganic binder component (B_{A}) comprises particles coated with a catalytically active layer or converted at least partially into a zeolite framework structure with retention of their particle form.
10. Catalyst (2) according to any of 1 to 9, in the form of an extruded catalyst, more particularly a honeycomb catalyst or a wall-flow filter.
11. Method for producing a catalyst (2) more particularly according to any of 1 to 10, comprising a small-pore catalytically active component (Z_{M,I}), mesopores being introduced into the small-pore component (Z_{M,I}) by alkaline treatment.
12. Method according to 11, in which a molecular sieve, more particularly a zeolite (Z_{M,I}), is used as small-pore active component.
13. Method according to 12, in which following the introduction of the mesopores by ion exchange, catalytically active metal ions are introduced into the small-pore component in order to form catalytically active cells.
14. Method according to 13, in which the molecular sieve following the introduction of the mesopores is alternatively directly metal ion-exchanged or is first converted into an intermediate form before the metal ion exchange takes place.
15. Method according to any of 11 to 14, in which a formable catalyst composition (E) is provided and is formed into a shaped body (4), in particular by extrusion, and the mesopores are introduced only after formation of the shaped body (4).

### LIST OF REFERENCE SYMBOLS

2 catalyst
4 honeycomb body
6 flow channels
Z small-pore zeolite
Z_{M} small-pore zeolite provided with mesopores
Z_{M,I} small-pore zeolite provided with mesopores and ion-exchanged
B binder component
B_{A} catalytically activated binder component
R residual component

1. A method of reducing nitrogen oxides in exhaust gas of an internal combustion engine by selective catalytic reduction (SCR), which method comprising contacting the exhaust gas also containing ammonia and oxygen with a catalytic converter comprising a catalyst comprising at least one crystalline small-pore molecular sieve catalytically active component (ZM,I) having a maximum ring opening of eight tetrahedral basic building blocks, which crystalline small-pore molecular sieve catalytically active component (ZM,I) comprising mesopores.

2. The method according to claim 1, wherein the at least one crystalline small-pore catalytically active component is an aluminosilicate zeolite, a silicoaluminophosphate molecular sieve or an aluminophosphate molecular sieve (ZM,I).

3. The method according to claim 1, wherein the molecular sieve comprises a promoter metal.

4. The method according to claim 3, wherein the crystalline molecular sieve is ion-exchanged with the promoter metal.

5. The method according to claim 3, wherein the promoter metal is iron or copper.

6. The method according to claim 1, wherein the crystalline molecular sieve is one or more of the framework structures CHA, AEI, ERI or AFX.

7. The method according to claim 1, comprising an inorganic binder component (B,BA).

8. The method according to claim 7, in which the inorganic binder component (B,BA) comprises porous particles having a mesoporosity with pore widths of 2-50 nm or macroporosity with pore widths of greater than 50 nm.

9. The method according to claim 7, wherein the inorganic binder component (BA) is catalytically activated.

10. The method according to claim 9, wherein the inorganic binder component (BA) comprises particles coated with a catalytically active layer or converted into a zeolite framework structure with retention of their particle form.

11. The method according to claim 1, wherein the catalyst is in the form of an extruded catalyst or wherein the catalyst is present as a washcoat on a catalytically inert, extruded support body.

12. The method according to claim 11, wherein the extruded catalyst is in the form of a honeycomb catalyst or a wall-flow filter.

13. The method according to claim 11 or 12, wherein a fraction of the crystalline small-pore molecular sieve catalytically active component (ZM,I) is in the range from 50 to 95 wt %, based on the total weight of the ultimately fabricated, sintered ceramic catalyst body.

14. A method for producing an extruded shaped body comprising a catalyst comprising at least one crystalline small-pore molecular sieve catalytically active component (ZM,I) and having a maximum ring opening of eight tetrahedral basic building blocks for use in a method according to any preceding claim, which crystalline small-pore molecular sieve catalytically active component (ZM,I) comprising mesopores, which method comprising preparing an extrudable composition comprising at least one crystalline small-pore molecular sieve catalytically active component (ZM,I) and having a maximum ring opening of eight tetrahedral basic building blocks, extruding the extrudable composition into a shaped body and introducing mesopores into the at least one crystalline small pore molecular sieve in the shaped body by alkaline treatment.

15. The method according to claim 14, wherein following the introduction of the mesopores, catalytically active promoter metal ions are introduced into the crystalline small-pore molecular sieve component in order to form catalytically active cells.

16. The method according to claim 15, wherein following the introduction of the mesopores the molecular sieve is directly metal ion-exchanged or is first converted into an intermediate form before the metal ion exchange takes place.

17. The method according to claim 15, wherein the promoter metal is iron or copper.
